(19) United States
(12) Patent Application Publication
(10) Pub. No.: US 2010/0177142 A1
(43) Pub. Date: Jul. 15, 2010

(54) INKJET PRINTER HAVING IMPROVED WIPER CLEANING FUNCTION

(75) Inventor: Gun HEO, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/511,366

(22) Filed: Jul. 29, 2009

(30) Foreign Application Priority Data
Jan. 12, 2009 (KR) 2009-0002387

(51) Int. Cl. B41J 2/165

(52) U.S. Cl. 347/33

(57) ABSTRACT

Provided is an inkjet printer having an improved wiper cleaning function, the inkjet printer including a tool to directly scrape ink on a wiper, suctioning the ink, and collecting the ink into a waste ink can.

### CROSS-REFERENCE TO RELATED APPLICATIONS

This application claims the benefit of Korean Patent Application No. 10-2009-0002387, filed on Jan. 12, 2009, in the Korean Intellectual Property Office, the disclosure of which is incorporated herein in its entirety by reference.

### BACKGROUND

1. Field of the Invention

The present general inventive concept relates to an inkjet printer having an improved function of cleaning a wiper to wipe a nozzle surface.

2. Description of the Related Art

In general, an inkjet printer is a printing device that prints predetermined images by ejecting ink droplets onto desired locations on a printing medium and can be classified as either a shuttle type inkjet printer or an array type inkjet printer. A shuttle type inkjet printer includes a print head including a single nozzle chip and prints by reciprocally moving the print head along the width direction of a printing medium. An array type inkjet printer includes a plurality of nozzle chips arranged along the width direction of a printing medium, and prints line by line. Recently, printers having an array type head are preferred due to increased printing speeds.

Meanwhile, when an inkjet print head is used to perform printing jobs repeatedly, a droplet ejection hole of a nozzle chip, i.e. a nozzle, may be contaminated by ink ejected from the nozzle. If the printing job is performed continuously, ink remaining on the nozzle and newly ejected ink are mixed with each other, preventing a clear color image from being printed. Thus, a wiping process to wipe a nozzle surface of a nozzle chip by using a wiper at an appropriate time, such as after or before the printing job starts, is performed.

However, repeated wiping processes cause contamination of the wiper due to accumulation of ink, and this may contaminate the nozzle surface. Therefore, an inkjet printer needs a function of cleaning a wiper so as to maintain a clean status.

### SUMMARY

Example embodiments of the present general inventive concept provide an inkjet printer including an inkjet head including a nozzle chip, a wiper unit comprising a wiper blade to wipe a nozzle surface of the nozzle chip and a housing to support the wiper blade and having an accommodation space therein, and a scraping unit to contact the wiper blade and to clean ink on the wiper blade into the accommodation space of the housing, wherein the scraping unit comprises a scraping shuttle installed to move along the width direction of the wiper blade.

Additional embodiments of the present general inventive concept will be set forth in part in the description which follows and, in part, will be obvious from the description, or may be learned by practice of the general inventive concept.

The scraping unit may further include a scraping portion disposed in the scraping shuttle to contact a part of the wiper blade that wipes the nozzle surface. The scraping portion may be formed to contact the wiper blade at an acute angle.

The scraping unit may further include a moving member to move the scraping shuttle along the width direction of the wiper blade. The moving member may include a belt connected to the scraping shuttle to travel along the width direction of the wiper blade, and a driving motor to drive the belt.

A cleaning roller to clean the nozzle surface according to the movement of the scraping shuttle may be installed in the scraping shuttle. A cleaning liquid and an ultrasonic device to vibrate the cleaning liquid to clean the nozzle surface may be disposed in the scraping shuttle.

The inkjet printer may further include a suction unit to suction the ink collected in the housing. The suction unit may include a waste ink can connected to the accommodation space of the housing through a tube, and a suction pump to provide suction to the waste ink can in the accommodation space through the tube.

Example embodiments of the present general inventive concept can also provide a wiper unit of an inkjet printer, including a wiper blade to wipe a nozzle surface of an inkjet head, a scraper unit to contact the wiper blade, and a shuttle unit to reciprocally move the scraper unit along the wiper blade to clean ink from the wiper blade.

The shuttle unit may include a cleaning unit to clean the nozzle surface as the shuttle unit moves along the wiper blade.

The wiper unit may further include a second shuttle unit to move the cleaning unit separately from the scraper unit.

Example embodiments of the present general inventive concept can also provide a method of cleaning an inkjet head, including reciprocally moving a wiper blade between a first position and a second position to wipe a nozzle surface of the inkjet head, and reciprocally moving a scraper unit along the wiper blade to clean ink from the wiper blade.

The method may further include directing the cleaned ink to a storage area to collect the cleaned ink.

The method may further include cleaning the nozzle surface as the scraper unit moves along the wiper blade.

### BRIEF DESCRIPTION OF THE DRAWINGS

These and/or other embodiments of the present general inventive concept will become apparent and more readily appreciated from the following description of the example embodiments, taken in conjunction with the accompanying drawings of which:

FIG. 1 is a perspective view of an inkjet printer having an improved wiper cleaning function according to an embodiment of the present general inventive concept;

FIG. 2 is a perspective view of a wiper cleaning tool included in the inkjet printer of FIG. 1;

FIG. 3 is a view of a scraping portion included in the wiper cleaning tool of FIG. 2;

FIGS. 4A through 4C are cross-sectional views to illustrate usage of the inkjet printer of FIG. 1; and

FIG. 5 is a diagram of a wiper cleaning tool according to another embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

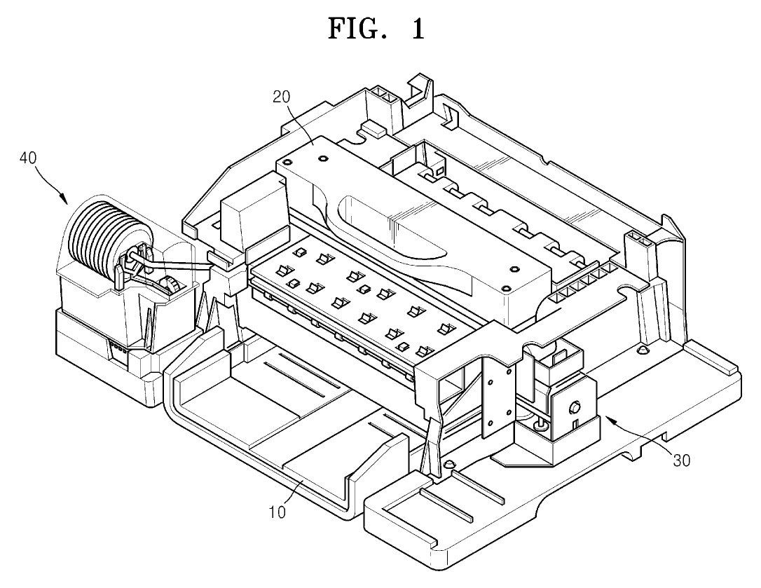

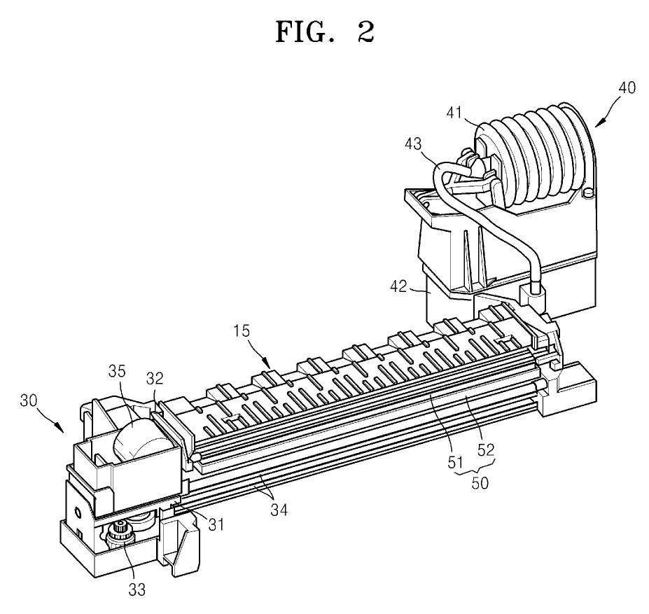

FIG. 1 is a perspective view of an inkjet printer having an improved wiper cleaning function according to an embodiment of the present general inventive concept. FIG. 2 is a perspective view of a wiper cleaning tool included in the inkjet printer of FIG. 1.

Referring to FIG. 1, the inkjet printer of the present embodiment can include an inkjet head 20 to print an image by ejecting ink droplets onto a printing medium. When a printing job starts, the printing medium can pass through a lower portion of the inkjet head 20, an image can be printed on a surface of the printing medium by using ink ejected by the inkjet head 20, and the printing medium on which the image is printed can be discharged to a cassette 10 and loaded thereon.

A wiper blade 51 to wipe a nozzle surface of the inkjet head 20 may be cleaned by a scraping unit 30. A suction unit 40 can be used to collect ink removed from the wiper blade 51. The scraping unit 30 and the suction unit 40 will be described in more detail with reference to FIG. 2.

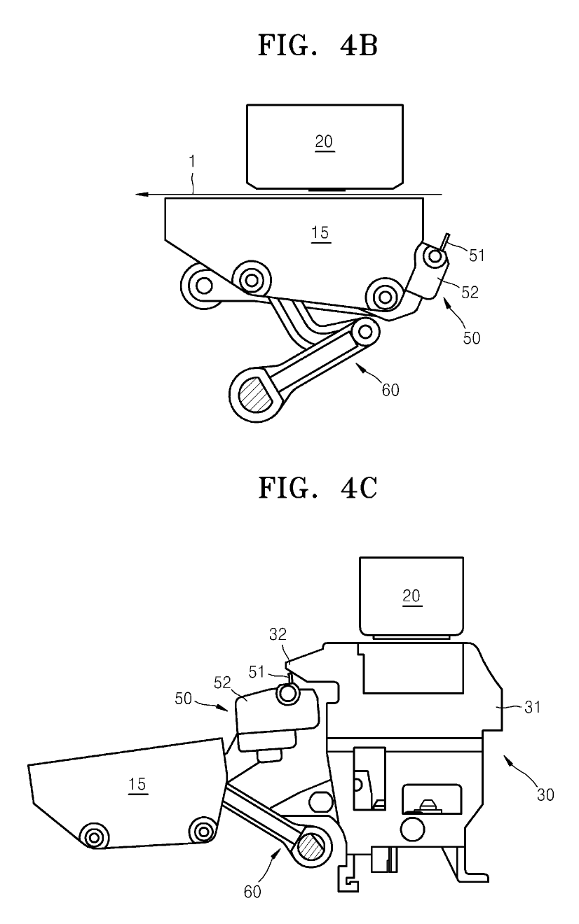

Referring to FIG. 2, a platen 15 can be used to support the printing medium in the lower portion of the inkjet head 20. A wiper unit 50 can be used to clean the nozzle surface of the inkjet head 20. The wiper unit 50 can be connected to the platen 15 by link members 60 (see FIG. 4A), and can include the wiper blade 51 to wipe the nozzle surface and a housing 52 to support the wiper blade 51. When the wiper blade 51 wipes the nozzle surface, a portion of wiped ink can be allocated to an accommodation space of the housing 52 and the remaining portion can remain on the wiper blade 51.

As illustrated in FIG. 2, the scraping unit 30 can be used to directly clean out the ink remaining on the wiper blade 51, and can be formed in the shape of a scraping shuttle 31 that is connected to a belt 34 that circulates by a driving motor 33 to reciprocally move with respect to the wiper unit 50. For example, while the scraping shuttle 31 can be moved by both the driving motor 33 and a moving member, such as the belt 34, a scraping portion 32 can be disposed on one side of the scraping shuttle 31 to directly contact the wiper blade 51 to clean the ink remaining on the wiper blade 51 and to direct the cleaned ink into the housing 52. A cleaning roller 35 may be installed in the scraping shuttle 31 to further clean the nozzle surface as the shuttle 31 is moving. For example, while the scraping shuttle 31 is reciprocally moved by the moving member, the cleaning roller 35 may be used to clean the nozzle surface once more. However, it is possible that the wiper blade 51 may be sufficiently cleaned using the scraping shuttle 31, in which case the cleaning roller 35 may be optionally installed.

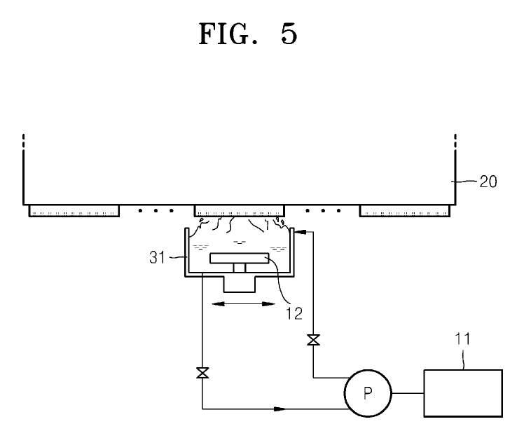

FIG. 5 is a diagram of a wiper cleaning tool according to another embodiment of the present general inventive concept. As illustrated in FIG. 5, an ultrasonic washing device may be provided to wash the nozzle surface by using an ultrasonic device 12. The ultrasonic device 12 may be installed to the scraping shuttle 31. For example, the scraping shuttle 31 can be filled with a cleaning liquid supplied by a storage tank 11. As the ultrasonic device 12 operates, the cleaning liquid can shake, and thus the nozzle surface may be washed. In other words, although the scraping portion 32 may be disposed in the scraping shuttle 31, the scraping portion 32 may be disposed in another shuttle to enable the scraping shuttle 31 to directly wash the nozzle surface by using a cleaning unit such as the cleaning roller 35 or the ultrasonic device 12 separately from the scraping portion 32. That is, although a member to reciprocally move along the width direction of the inkjet head 20 can be referred to as the scraping shuttle 31 for convenience of description, it is possible that another reciprocally moving shuttle can be provided to move the scraping portion 32 separately from the scraping shuttle 31 to directly clean the wiper blade 51 without departing from the broader principles and spirit of the present general inventive concept.

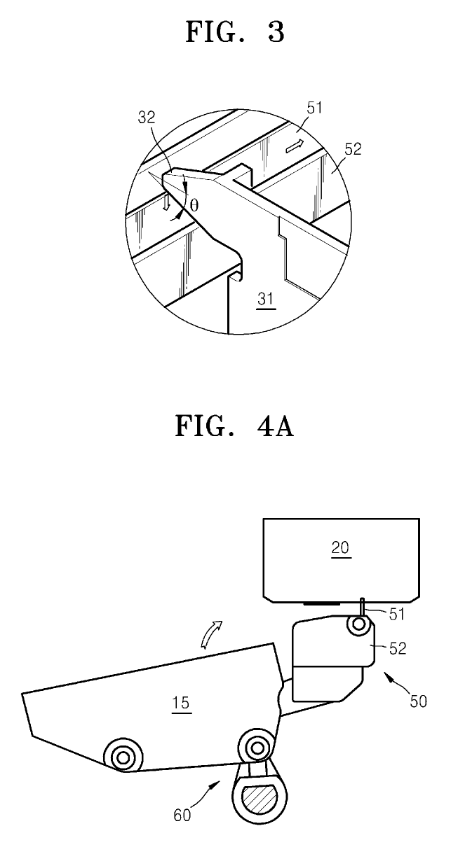

In any case, the scraping portion 32 can be inclined to contact the wiper blade 51 at an acute angle θ as illustrated in FIG. 3, so that a leading edge of the wiper blade 51 softly bends in the opposite direction of the scraping portion 32 and thus the scraping portion 32 contacts the wiper blade 51.

The suction unit 40 can be used to collect the ink stored in the housing 52, and can include a tube 43 that is connected to the accommodation space of the housing 52, a suction pump 41 that provides suction, and a waste ink can 42 that stores absorbed ink. Therefore, when the suction pump 41 operates, the ink stored in the accommodation space of the housing 52 can be suctioned into the waste ink can 42 through the tube 43.

The inkjet printer may be used as illustrated in FIGS. 4A through 4C.

When a printing job starts, referring to FIG. 4A, the platen 15 in a printing standby position can start to move toward the lower portion of the inkjet head 20. In this regard, the platen 15 and the wiper unit 50 connected to the link members 60 can move together so that the wiper blade 51 may clean out the nozzle surface of the inkjet head 20.

Referring to FIG. 4B, when the platen 15 is disposed in the lower portion of the inkjet head 20, a printing medium 1 may pass through the platen 15 and the inkjet head 20 and thus the printing job may proceed.

Thereafter, when a printing standby status comes after the printing job ends, referring to FIG. 4C, the platen 15 and the wiper unit 50 can be returned to the printing standby position from the lower portion of the inkjet head 20, in which the scraping unit 30 operates. Then, the scraping shuttle 31 can move along the width direction of the wiper blade 51 and thus the ink remaining on the wiper blade 51 can be cleaned out into the accommodation space of the housing 52 by using the scraping portion 32. Thereafter, the suction pump 41 can be controlled to operate at an appropriate time, and the ink stored in the housing 52 can be collected into the waste ink can 42 through the tube 43. In this regard, if the cleaning roller 35 is installed in the scraping shuttle 31, the cleaning roller 35 may be used to wipe the nozzle surface, or, if the ultrasonic device 12 is installed in the scraping shuttle 31, the nozzle surface may be cleaned with the cleaning liquid by the vibration of the ultrasonic device 12.

Therefore, the wiper blade 51 may remain in a clean status so that wiping makes it possible to reliably clean the nozzle surface. Thus, the inkjet printer of the present embodiment can secure a stable printing job

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An inkjet printer comprising:
an inkjet head including a nozzle chip;
a wiper unit comprising a wiper blade to wipe a nozzle surface of the nozzle chip and a housing to support the wiper blade and having an accommodation space therein; and
a scraping unit to contact the wiper blade and to clean ink on the wiper blade into the accommodation space of the housing,
wherein the scraping unit comprises a scraping shuttle installed to move along the width direction of the wiper blade.

2. The inkjet printer of claim 1, wherein the scraping unit further comprises a scraping portion disposed in the scraping shuttle to contact a part of the wiper blade that wipes the nozzle surface.

3. The inkjet printer of claim 2, wherein the scraping portion is formed to contact the wiper blade at an acute angle.

4. The inkjet printer of claim 1, wherein the scraping unit further comprises a moving member to move the scraping shuttle along the width direction of the wiper blade.

5. The inkjet printer of claim 4, wherein the moving member comprises a belt connected to the scraping shuttle to travel along the width direction of the wiper blade, and a driving motor to drive the belt.

6. The inkjet printer of claim 1, wherein a cleaning roller to clean the nozzle surface according to the movement of the scraping shuttle is installed in the scraping shuttle.

7. The inkjet printer of claim 1, wherein a cleaning liquid and an ultrasonic device to vibrate the cleaning liquid to clean the nozzle surface are disposed in the scraping shuttle.

8. The inkjet printer of claim 1, further comprising a suction unit to suction the ink collected in the housing.

9. The inkjet printer of claim 8, wherein the suction unit comprises:
a waste ink can connected to the accommodation space of the housing through a tube; and
a suction pump to provide suction to the waste ink can in the accommodation space through the tube.

10. A wiper unit of an inkjet printer comprising:
a wiper blade to wipe a nozzle surface of an inkjet head;
a scraper unit to contact the wiper blade; and
a shuttle unit to reciprocally move the scraper unit along the wiper blade to clean ink from the wiper blade.

11. The wiper unit of claim 10, wherein the shuttle unit comprises a cleaning unit to clean the nozzle surface as the shuttle unit moves along the wiper blade.

12. The wiper unit of claim 11, further comprising:
a second shuttle unit to move the cleaning unit separately from the scraper unit.

13. A method of cleaning an inkjet head comprising:
reciprocally moving a wiper blade between a first position and a second position to wipe a nozzle surface of the inkjet head; and
reciprocally moving a scraper unit along the wiper blade to clean ink from the wiper blade.

14. The method of claim 13, further comprising:
directing the cleaned ink to a storage area to collect the cleaned ink.

15. The method of claim 13, further comprising:
cleaning the nozzle surface as the scraper unit moves along the wiper blade.
